(19) United States
(12) Patent Application Publication
(10) Pub. No.: US 2002/0030692 A1
(43) Pub. Date: Mar. 14, 2002

(54) Method for generating a picture in a virtual studio

(76) Inventor: Arnfried Griesert, Leichlingen (DE)

Correspondence Address: BIRCH STEWART KOLASCH & BIRCH, PO BOX 747, FALLS CHURCH, VA, 22040-0747, US

(21) Appl. No.: 09/947,452

(22) Filed: Sep. 7, 2001

(30) Foreign Application Priority Data
Sep. 8, 2000 (DE) 100 44 499.7
Nov. 4, 2000 (DE) 100 54 835.0

(51) Int. Cl. G06K 9/00; G06K 9/36; G09G 5/00

(52) U.S. Cl. 345/619; 382/284; 382/103

(57) ABSTRACT

Method for generating a picture in a virtual studio The method for generating a picture in a virtual studio wherein a real object, particularly an anchorperson, is projected onto a virtual object, which can be e.g. the virtual floor on which the real object appears to be standing in the generated picture, comprises the following steps:

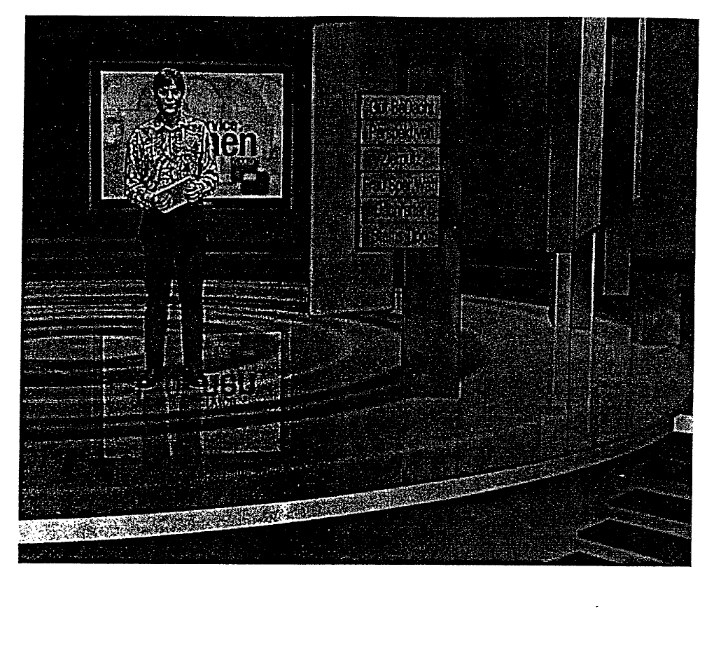

providing a memory for the pixels corresponding to the virtual object in the generated picture,

in said memory, marking first positions corresponding to first regions of the virtual object in which, due to the contour or nature of the virtual object, a projection of the real object is to be performed,

writing picture data of the projection of the real object into said memory, notably within said first positions, and

displaying the picture to be generated resulting from a superposition of the virtual object, the real object and the virtual object corresponding to the contents of said memory.

### BACKGROUND OF THE INVENTION

The present invention relates to the generating of a picture in a virtual studio wherein a real object, e.g. an anchorperson, is projected onto a virtual object, which particularly can be the virtual floor on which the real object appears to be standing in the generated picture. Particularly, the invention relates to a method for the integration (generation) of seemingly realistic reflections of real objects in virtual sets.

Virtual studios are used in a large number of television and movie productions.

Such studios make it possible to generate pictures in which a real object, e.g. an anchorperson or actor, moves in a virtual environment. Occasionally, it is required to project the real object onto a virtual object. An example of such a projection is the mirror picture which the real object (anchorperson) generates on the (virtual) floor. As of yet, for this purpose, the (real) floor on which the real object stands has been designed to be (partially) reflecting. In virtual studios, for instance, use has been made of floors made from transparent plastic or similar materials, allowing the picture taken of the real object to be recorded together with the mirror picture of the real object. This technique, however, entails the risk of errors in the mutual superposition of the real picture and the virtual picture. Further, this technique is relatively complex.

There has already been proposed another studio technology wherein the real object is inserted into the to-be-generated picture while mirrored about an axis. This approach will cause an imperfect picture especially when the picture to be generated includes virtual elements which should be positioned before the real object. Such a virtual element could be e.g. a table, with the anchorperson (virtual picture) standing or seated behind it. Further, the contours of the virtual picture may cause problems in this prior art approach.

It is an object of the present invention to provide a method for generating a picture in a virtual studio which is suited to obtain a more realistic reproduction of projections of real objects onto virtual objects.

### SUMMARY OF THE INVENTION

According to the instant invention, the above object is achieved by a method for generating a picture in a virtual studio wherein a real object, particularly an anchorperson, is projected onto a virtual object, which can be e.g. the virtual floor on which the real object appears to be standing in the generated picture, said method comprising the following steps:

providing a memory for the pixels corresponding to the virtual object in the generated picture,

in said memory, marking first positions corresponding to first regions of the virtual object in which, due to the contour or nature of the virtual object, a projection of the real object is to be performed,

writing picture data of the projection of the real object into said memory, notably within said first positions, and

displaying the picture to be generated resulting from a superposition of the virtual object, the real object and the virtual object corresponding to the contents of said memory.

In the method of the invention, the position of the real object relative to the virtual object having the real object projected thereon is known. Likewise, of course, the position of the real object within the rest of the virtual environment is known. It is to be defined which part of the picture to be generated is the virtual object onto which the real object will be projected. The data for the pixels of this virtual object in the picture to be generated are stored in a memory. Depending on the nature and the appearance of the virtual object, the case can occur that a projection of the real object must not appear on the virtual object in the picture to be generated. Thus, for instance, it may happen that the virtual floor on which the anchorperson is placed as a real object comprises reflecting and non-reflecting regions. Then, of course, the projection of the anchorperson in the picture to be generated should be seen only within the reflecting regions. Thus, according to the invention, all positions which represent those regions of the virtual object in the generated picture where a projection of the real object is to occur, will be marked in the memory provided for the picture data (pixels) of the virtual object in the generated picture. When the projection data are written into the memory, these projection data are written into the previously marked positions in the memory. Accordingly, the subsequent generation of the picture by mutual superposition of the virtual object, the real object and the virtual object corresponding to the contents of said memory will result in a realistic reproduction of the projection of the real object onto the virtual object in the virtual environment.

For situations where virtual elements (e.g. tables) are arranged between the real object and the projection thereof on the virtual object, it is provided, according to a preferred variant of the instant invention, to mark additionally those positions in the memory which coincide with the previously marked positions and which correspond to regions of the virtual object where, due to a projection of the above virtual element onto the virtual object, a projection of the real object is not allowed. In this manner, it is safeguarded that the projection of the real object will not undesirably appear within the projection of the virtual element onto the virtual object. If, for instance, the anchorperson in a virtual studio should appear sitting or standing behind a virtual table, a virtual counter or the like, it is accomplished by the above variant that every region where the table or the counter is reflected on the floor will be free of a mirror reflection of the anchorperson. Further preferred embodiments and aspects of the instant invention will be evident from the following detailed description which is rendered on the assumption that the operating method of a virtual studio is as such known.

### DETAILED DESCRIPTION OF A PREFERRED EMBODIMENT

The principle of the method of the invention is based on the projection of the anchorperson in a blue or differently-colored space onto a virtual object on the set, which object is particularly the virtual floor. In the process, the projection is coupled to the position of the anchorperson (particularly through optical tracking or other methods for following the position of the anchorperson).

First, a (virtual) object is designated e.g. as a floor. This object can be a rectangle, a plate or another object of a different desired shape. In a first rendering step, this object is rendered in a separate buffer (in some systems, also referred to as a “stencil puffer”). This buffer is required in order to correctly cut off the reflections toward the edge of the floor.

In the above buffer, a first value (e.g. 1) is written into those positions where the reflected objects are to appear, while a second value (e.g. 0) is written into all other positions where the reflected objects are not to appear. Then, the whole scene is rendered in an orientation mirrored about the y-axis (i.e. horizontally) but only in those regions where the memory positions comprise the first value. Also the lighting sources are mirrored correctly in their positions to allow for a correct computation of the lighting.

Since objects can be switched separately to have them appear in the foreground, a third value is written for these objects into corresponding positions of the stencil buffer. Thereby, it can be precluded that the projection of the anchorperson is written into those positions of the stencil buffer which are occupied by the third value.

The reflection of the anchorperson is now obtained directly from the real camera picture which is passed through a chroma keyer providing the picture with a mask in the alpha channel. Thereby, the picture of the anchorperson is separated from the blue or differently colored background. The thus obtained picture is screened and rendered into the frame buffer.

The rendering is, however, performed only where the buffer contains the first value. Thus, virtual objects which have been switched into the foreground will indeed be visible at positions in front of the anchorperson. By the testing for the first value, also the edge of the floor is correctly rendered.

The floor itself is subsequently computed by simple blending over the scene rendered up to now. Prior thereto, the virtual light sources are placed again in their original positions.

In a final step, the complete scene which is located above the floor will be rendered. A clipping, suitably set for the purpose, will prevent the occurrence of errors caused by objects which extend into the floor and thus would have undesired effects in mirroring. This, however, is of mere secondary relevance for the reflection of the anchorperson proper.

What is still in need to be defined in the instant method is the position (horizontal line) in which the camera picture is mirrored. This horizontal line can be expressed as a line of pixels. Several possibilities exist for this definition process. If it is to be expected that the camera will not be moved, a manual adaptation of the horizontal mirroring axis can be performed. Alternatively, this mirroring axis can be computed automatically from the position of the anchorperson in the coordinate system of the set. Also the anchorperson's position can either be input manually or be obtained by using a—particularly optical—tracking system for the anchorperson wherein the position of the latter is computed, by use of image detection systems, from the pictures delivered by a a plurality of cameras. In this manner, the position of the anchorperson is obtained automatically so that the system will then compute the line about which the camera picture has to be mirrored.

The advantages of the instant method as compared to conventional methods are in essence the following:

Contours of the floor will be detected; mirroring and non-mirroring regions of the floor will be differentiated from each other.

Virtual objects can be switched to have them appear in the foreground.

A transparence of the anchorperson's reflection in front of virtual objects is avoided; as a result, the sets can comprise a bright background or a bright virtual floor without causing a negative influence on the reflection of the anchorperson or, in a wider sense, the projection of real objects.

From the attached photographic picture, it is evident how “true to nature” the virtually generated projection will be. The picture shows a set wherein the floor consists of a reflecting disk on whose edge the reflection of the virtual objects and of the real object (anchorman) has been correctly cut off. This is made possible because the silhouette of the floor has been stored in the buffer; in other words, those regions into which projection data of the real and the virtual objects are allowed to be written are defined in the buffer.

Upon closer inspection of the attached photographic picture, it can be seen that the reflection of the anchorperson is not impaired by a transparent part of the reflecting background. Such an occurrence would cause problems when using transparent plastic for the studio floor. Further, the set is kept in a very bright tone. This at the very least would cause transparency problems in the conventional technology for generating projections of real and virtual objects in a virtual environment.

1. A method for generating a picture in a virtual studio wherein a real object, particularly an anchorperson, is projected onto a virtual object, which can be e.g. the virtual floor on which the real object appears to be standing in the generated picture, said method comprising the following steps:
providing a memory for the pixels corresponding to the virtual object in the generated picture,
in said memory, marking first positions corresponding to first regions of the virtual object in which, due to the contour or nature of the virtual object, a projection of the real object is to be performed,
writing picture data of the projection of the real object into said memory, notably within said first positions, and
displaying the picture to be generated resulting from a superposition of the virtual object, the real object and the virtual object corresponding to the contents of said memory.

2. The method according to claim 1, further comprising the following steps:
in said memory, marking second positions corresponding to those regions of the virtual object located within the first regions, in which, for projecting onto the virtual object a virtual element such as e.g. a table or the like arranged before the real object, a projection of the real object is not to be performed,
in said memory, writing picture data of the projection of the real object only into those memory positions which coincide only with the first positions, and
displaying the picture to be generated resulting from a superposition of the virtual object, the real object and the virtual object corresponding to the contents of said memory.

3. The method according to claim 1, further comprising the step of writing picture data of the projection of a virtual background arranged behind the real object into said memory, notably into those positions in said memory which are identical with the first or the second positions.

4. The method according to claim 1 wherein the position of the real object is fixed or can be input manually or be tracked automatically, particularly by optical means.

5. The method according to claim 1 wherein the reflectance of the virtual object appearing in the image to be generated can be adjusted.
